(19) United States
(12) Patent Application Publication
(10) Pub. No.: US 2011/0167866 A1
(43) Pub. Date: Jul. 14, 2011

(54) SYSTEM AND METHOD FOR SEPARATING GASSES IN AN EXHAUST GAS

(76) Inventor: LINCOLN EVANS-BEAUCHAMP, Palo Alto, CA (US)

(21) Appl. No.: 12/729,766

(22) Filed: Mar. 23, 2010

Related U.S. Application Data
(63) Continuation-in-part of application No. 12/720,481, filed on Mar. 9, 2010.
(60) Provisional application No. 61/293,609, filed on Jan. 8, 2010.

(51) Int. Cl. F25J 3/00; F02C 1/04

(52) U.S. Cl. 62/617; 60/682; 60/684

(57) ABSTRACT

A system is provided for separating carbon dioxide emitted in exhaust gas from nitrogen gas. A compressor may be used for compressing the emitted exhaust gas and a heat exchanger may be used for cooling the compressed exhaust gas to liquid carbon dioxide temperatures. The liquid carbon dioxide may be separated from the compressed nitrogen gas and stored. A turbine may use the compressed nitrogen gas to drive the compressor, while further cooling the compressed nitrogen to cryo-temperatures. Heat exchangers may be used for transferring heat energy from emitted exhaust and the compressed exhaust to the cold compressed nitrogen, thus, conserving energy of the system.

### CROSS-REFERENCE TO RELATED APPLICATIONS

The present application claims the priority and benefit of U.S. patent application Ser. No. 12/720,481 titled “SYSTEM AND METHOD FOR SEQUESTERING EMISSIONS FROM ENGINES,” filed Mar. 9, 2010, and of U.S. patent application No. 61/293,609 titled “Zero-Emissions Engines,” filed Jan. 8, 2010. The disclosures of all of the above U.S. patent applications are incorporated by reference herein in their entirety.

### BACKGROUND

1. Field of the Invention

The present disclosure generally relates to emission control systems. The present disclosure more specifically relates to separating gasses in exhaust emissions from combustion of a fuel.

2. Description of Related Art

Generally ambient air is used for combustion of fuel. Ambient air includes about 80% nitrogen gas and about 20% oxygen. Consequently, exhaust gas emitted from the combustion of fuel primarily includes a mixture of carbon dioxide gas and water vapor produced resulting from the combustion process and nitrogen gas from the ambient air. Water vapor can be condensed from exhaust gas according to standard techniques and safely returned to the environment. Separation of the carbon dioxide from nitrogen is an important step in recovering the carbon dioxide from the emitted exhaust gas. Unfortunately, separation of carbon dioxide from nitrogen requires complex chemistry involving potentially hazardous chemicals and/or substantial amounts of energy.

### SUMMARY

In an embodiment of the presently claimed invention, exhaust gas emitted from combustion of fuel may be compressed using a compressor and then cooled to liquid carbon dioxide temperature. Liquid carbon dioxide in the compressed exhaust gas may be separated from cold nitrogen gas. The separated cold nitrogen gas maybe used to drive a turbine, which in turn drives the compressor. The system includes heat exchangers for cooling the exhaust gas while heating nitrogen gas, thus, transferring heat energy from the exhaust gas to the nitrogen gas for use in driving the turbines.

In an embodiment of the presently claimed invention, a system is provided for separating carbon dioxide from nitrogen in exhaust gas from combustion of fuel. The system comprises a compressor configured to compress the exhaust gas and a heat exchanger configured to cool the compressed exhaust gas to liquid carbon dioxide temperature. A fluid trap is configured to separate liquid carbon dioxide from compressed nitrogen gas in the compressed exhaust gas and store the separated liquid carbon dioxide in a tank. A turbine coupled to the compressor is in communication with the fluid trap. The turbine is configured to use the separated compressed nitrogen gas from the fluid trap for driving the compressor. The turbine may include a first stage and a second stage. The heat exchanger is configured to warm the nitrogen gas between the first stage and the second stage using heat received from cooling the compressed exhaust gas to liquid carbon dioxide temperature. A regenerative heat exchanger is configured to cool the exhaust gas from a combustion temperature to ambient temperature before introduction into the compressor and to warm the nitrogen gas between the first stage and the second stage using heat transferred from cooling the exhaust gas.

In an embodiment of the presently claimed invention, a method is provided for separating carbon dioxide from nitrogen in exhaust gas emitted from a combustion of fuel. In this method, the emitted exhaust gas is compressed in a compressor from ambient pressure to high pressure and then cooled from ambient temperature to liquid carbon dioxide temperature. Liquid carbon dioxide is separated from high-pressure nitrogen gas at liquid carbon dioxide temperature and the separated high-pressure nitrogen gas is used for driving a turbine, which in turn drives the compressor. The method includes exchanging heat between the compressed exhaust gas and nitrogen gas released from the turbine. The exchange of heat may be used to cool the compressed exhaust gas to liquid carbon dioxide temperature and to warm the released nitrogen gas. The turbine may include two or more stages configured to drive the compressor. The method further includes releasing medium pressure nitrogen gas from the first stage of the turbine at cryo-temperature and exchanging heat between the emitted exhaust gas and the medium pressure nitrogen gas to cool the emitted exhaust gas and to heat the medium pressure nitrogen gas. The method also includes driving a second stage of the turbine using the heated medium pressure nitrogen gas and releasing ambient pressure nitrogen gas from the second stage.

In an embodiment of the presently claimed invention, a system is described for separating carbon dioxide from nitrogen in exhaust gas emitted during combustion of fuel. The system includes a regenerative heat exchanger configured to cool hot exhaust gas from combustion temperature to ambient temperature and a compressor configured to compress the ambient-temperature exhaust gas from ambient pressure to high pressure. The system further includes a cryo heat exchanger configured to cool the high-pressure exhaust gas from ambient temperature to cryo-temperature and a fluid trap configured to separate liquid carbon dioxide from nitrogen gas in the cryo-temperature exhaust. A two stage turbine may be in fluid communication with the fluid trap, the cryo heat exchanger, and regenerative heat exchanger. The first stage of the turbine may be configured to use the high-pressure nitrogen gas from the fluid trap for driving the compressor and to release the nitrogen gas at a medium pressure. The cryo heat exchanger may be configured to warm the medium pressure nitrogen gas released from the first stage using the cooling of the high-pressure exhaust gas. The regenerative heat exchanger may be configured to warm the medium pressure nitrogen gas from the cryo heat exchanger using the cooling of the hot exhaust gas. The second stage turbine may be configured to use the warmed nitrogen gas from the regenerative heat exchanger to drive the compressor.

### BRIEF DESCRIPTION OF THE DRAWINGS

FIG. 1 is a block diagram illustrating an exemplary embodiment of a system for separation of carbon dioxide from nitrogen, according to aspects of the invention.

FIG. 2 is a block diagram illustrating an alternate embodiment of a system for separation of carbon dioxide from nitrogen, according to aspects of the invention.

FIG. 3 is a block diagram illustrating details of a fluid trap and tank of FIG. 1 or 2.

FIG. 4 is a block diagram illustrating details of compressors and an intercooler of FIG. 1 or 2.

FIG. 5 is a block diagram illustrating an alternate embodiment of details of a cryo heat exchanger, fluid trap, and tank of FIG. 1 or 2.

FIG. 6 is a block diagram illustrating an alternate embodiment of details of a cryo heat exchanger, fluid trap, and tank of FIG. 1 or 2.

FIG. 7 is a flow diagram of an exemplary process for separating carbon dioxide from nitrogen.

FIG. 8 is a block diagram illustrating a use of the system of FIG. 1 in a combustion system.

### DETAILED DESCRIPTION

A system is described for compressing and cooling hot exhaust gas to liquid carbon dioxide temperature for separation into liquid carbon dioxide and nitrogen gas, and then heating the nitrogen gas to drive a turbine. The turbine may be coupled to a compressor for compressing the exhaust gas. The turbine may have multiple stages. The system includes one or more heat exchangers between stages of the turbine. The heat exchangers may be used for cooling the exhaust gas while heating nitrogen gas, thus, transferring heat energy from the exhaust gas to the nitrogen gas for use in driving one or more stages of the turbine.

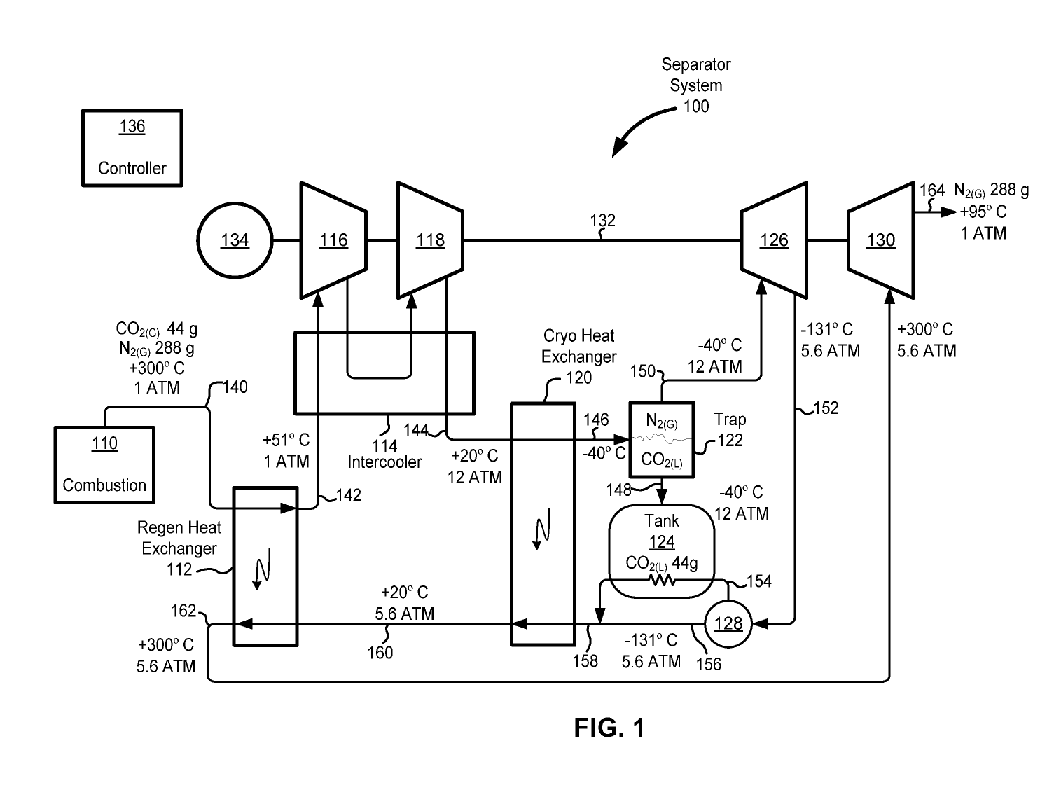

FIG. 1 is a block diagram illustrating an exemplary embodiment of a system 100 for separation of carbon dioxide from nitrogen, according to aspects of the invention. The system 100 includes a regenerative heat exchanger 112, a first stage compressor 116, a second stage compressor 118, an optional intercooler 114, a cryo heat exchanger 120, a fluid trap 122, a tank 124, a cryo turbine 126, an optional temperature control bypass valve 128, and a power turbine 130.

A combustion source 110 emits exhaust gas 140 from combustion of fuel, e.g., methane with ambient air containing oxygen, nitrogen, and other trace gases. The exhaust gas 140 may be emitted at a combustion temperature and an ambient pressure of about 1 atmosphere (ATM). A range of combustion temperatures includes about +250° to 800° Celsius (C). For simplicity, a combustion temperature of +300° C. is used for describing the exhaust gas 140. The exhaust gas 140 includes a mixture of mostly carbon dioxide, nitrogen gases, and water vapor along with trace gases such as argon, oxides of nitrogen (NOx), oxides of sulfur (SOx), and oxides of carbon (COx) comprising less than 1-2 percent. For simplicity, the trace gases are ignored in describing operation of the system 100 of FIG. 1. An exemplary flow of the exhaust gas 140 of FIG. 1 includes a mixture of 44 grams (g) of carbon dioxide gas and 288 g nitrogen gas per unit time. The system 100 may process this flow of exhaust gas 140 while storing about 44 g of liquid carbon dioxide and releasing about 288 g of nitrogen gas per unit time.

The regenerative heat exchanger 112 may be used to cool the exhaust gas 140 from combustion temperature to ambient temperature. Ambient temperature may be in a range of about −20° to +100° C. The regenerative heat exchanger 112 of FIG. 1 cools the exhaust gas 140 from about +300° C. to about +51° C. The regenerative heat exchanger 112 may use a flow of ambient temperature nitrogen gas 160 from the cryo heat exchanger 120 for cooling the exhaust gas 140. The regenerative heat exchanger 112 may also be used for removing the water vapor from the exhaust gas 140. Alternatively, water vapor may be removed from the exhaust gas 140 before or after being introduced into the regenerative heat exchanger 112. The regenerative heat exchanger 112 of FIG. 1 outputs cooled exhaust gas 142 at an ambient temperature of about +51° C. and 1 ATM. Examples of the regenerative heat exchanger 112 include a reverse flow heat exchanger, a plate type heat exchanger, a shell and tube type heat exchanger, a tube type heat exchanger, rotary type heat exchanger and/or the like.

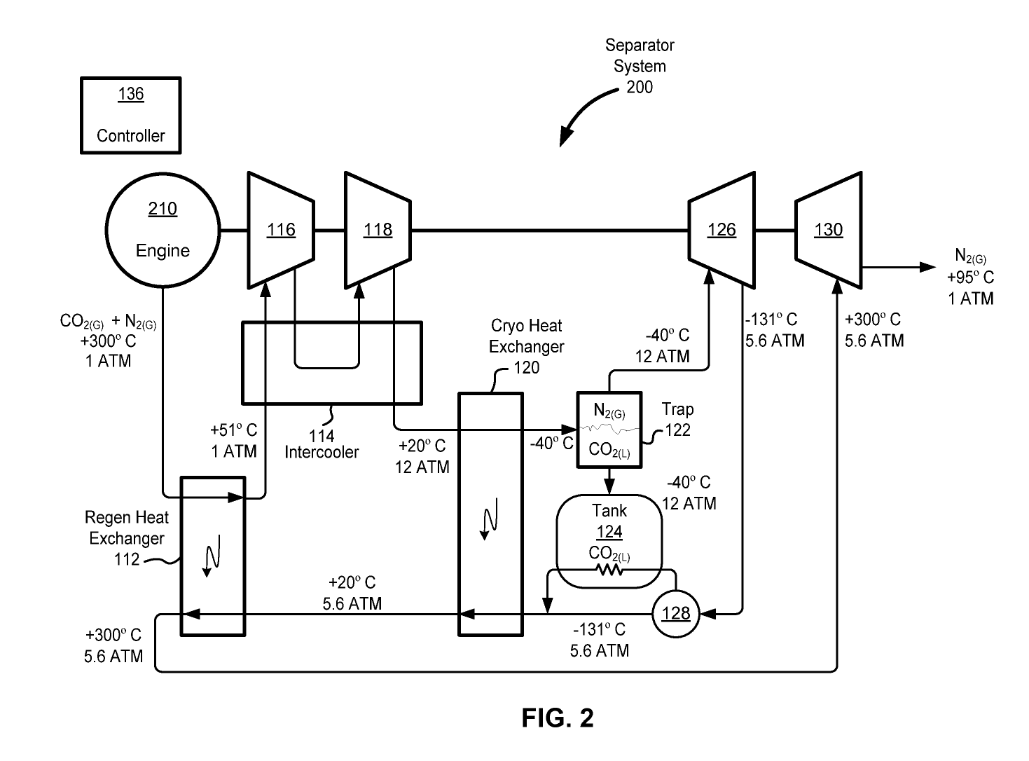

The first stage compressor 116 receives the exhaust gas 142 via the intercooler 114. The first stage compressor 116 and the second stage compressor 118 may form a two stage compressor for compressing the exhaust gas 142 to about high pressure. High pressure includes pressures greater than about 8 ATM. The intercooler 114 may be used to remove heat from the exhaust gas 142 as described elsewhere herein. For example, the intercooler 114 may transfer the heat to ambient surroundings. The second stage compressor 118 may output compressed exhaust gas 144 at high pressure of about 12 ATM and an ambient temperature of about 20° C. While a two stage compressor is illustrated in FIG. 2, more or fewer stages of compression may be used to compress the exhaust gas 142 and output compressed exhaust gas 144 at high pressure.

The cryo heat exchanger 120 may receive compressed exhaust gas 144 from the second stage compressor 118 via the intercooler 114. The cryo heat exchanger 120 is configured to cool the compressed exhaust gas 144 from ambient temperature to a cryo-temperature. Generally, cryo-temperatures may be considered to range from a little above −273° C. to about −30° C. The cryo-temperature of the cooled exhaust may be about a temperature of compressed liquid carbon dioxide at a pressure of greater than about 7-8 ATM. For example, the cryo heat exchanger of FIG. 1 outputs cold exhaust 146 comprising a mixture of liquid carbon dioxide and nitrogen gas at about 12 ATM and −40° C. At a temperature of less than about −35° C., carbon dioxide is a liquid at about 12 ATM. However, higher temperatures and pressures may be used. For example, at a temperature of about 0° C., carbon dioxide is a liquid at about 35 ATM. In such an example, cryo-temperature may be considered to be a temperature below about 0° C.

The fluid trap 122 is configured to separate liquid carbon dioxide 148 from nitrogen gas 150 and provide the liquid carbon dioxide 148 to the tank 124. The fluid trap 122 of FIG. 1 receives the cold exhaust 146 from the cryo heat exchanger 120 at a temperature of about −40° C. and a pressure of about 12 ATM. At this temperature and pressure, the carbon dioxide is in a liquid state and the nitrogen is in a gas state. However, other temperatures and pressures may be selected at which the carbon dioxide is in a liquid state and the nitrogen is in a gas state. The liquid carbon dioxide may settle to the bottom of the fluid trap 122 where it may be released to the tank 124, while nitrogen gas 150 bubbles to the top. In some embodiments, the fluid trap 122 and the tank 124 may be combined in a single module. The tank 124 is configured to store the liquid carbon dioxide 148.

The cryo-turbine 126 is configured to cool the separated nitrogen gas 150 and drive the compressors 116 and 118. The fluid trap 122 of FIG. 1 may provide the separated nitrogen gas 150 to the cryo-turbine 126 at about −40° C. and 12 ATM. The cryo-turbine 126 may release the separated nitrogen gas 150 as medium pressure nitrogen gas 152 at a lower temperature. The cryo-turbine 126 may use energy extracted from the nitrogen gas to drive the compressor 116 and/or 118 via a coupling 132. For an ideal turbine, the medium pressure may be about 5-6 ATM and the lower temperature may be about −130° C. As the flow of nitrogen gas increases, a turbine is generally more efficient. At a low flow, a turbine may have an efficiency of about 50%. However, a piston engine may have an efficiency of greater than 90%. Thus, at a low flow it may be desirable to substitute a piston engine for the cryo-turbine 126. Alternatively, a nozzle may be substituted for the cryo-turbine 126 to release the medium pressure nitrogen gas 152 at about 5-6 ATM and −130° C. While the nozzle will not produce any mechanical energy for driving the compressors 116 and 118, the mechanical energy available in the separated nitrogen gas 150 may be negligible at some temperatures and pressures.

The bypass valve 128 may be used to selectively direct the medium pressure nitrogen gas 152 to the tank 124 or to bypass the tank 124. The bypass valve 128 may direct all or a portion of the flow of the medium pressure nitrogen gas 152 through the tank 124 as cold nitrogen gas 154. Since the cold nitrogen gas 154 may be at a temperature of about −130° C. and a target temperature for the tank 124 may vary from ambient at startup to about −40° C. during operation, the cold nitrogen gas 154 may be used for cooling the tank 124 or maintaining a desired temperature for the tank 124. The bypass valve 128 may direct all or a portion of the flow of the medium pressure nitrogen gas 152 to bypass the tank 124 as bypass nitrogen gas 156.

The cryo heat exchanger 120 is configured to capture and conserve heat energy from cooling compressed exhaust gas 144 and warming nitrogen gas 158. The cryo heat exchanger 120 receives nitrogen gas 158 which is a combination of the cold nitrogen gas 154 and the bypass nitrogen gas 156. The cryo heat exchanger 120 may warm the nitrogen gas 158 to ambient temperature nitrogen gas 160, using heat energy from the compressed exhaust gas 144. The cryo heat exchanger 120 may use the nitrogen gas 158 to cool the compressed exhaust gas 144 from ambient temperature to about −40° C. Thus, heat energy from the compressed exhaust gas 144 may be captured and conserved.

The regenerative heat exchanger 112 is configured to capture and conserve heat energy from cooling the hot exhaust gas 140 and warming ambient temperature nitrogen gas. The regenerative heat exchanger 112 may receive the ambient temperature nitrogen gas 160 from the cryo heat exchanger 120. The regenerative heat exchanger 112 may warm the ambient temperature nitrogen gas 160 to hot nitrogen gas 162 using heat energy from the hot exhaust gas 140. Thus, heat energy from the hot exhaust gas 140 may be captured and conserved.

The power turbine 130 is configured convert energy in the hot nitrogen gas 162 to mechanical energy to drive the compressors 116 and/or 118. The power turbine 130 may receive hot nitrogen gas 162 from the regenerative heat exchanger 112 at medium pressure and release nitrogen gas at ambient temperature and pressure. For example, the power turbine 130 may receive hot nitrogen gas at about +300° C. and 5-6 ATM and release nitrogen gas 164 at about +95° C. and 1 ATM. The power turbine 130 may drive the compressor 116 and/or 118 via the coupling 132.

A motor 134 may be used for driving the compressor. The motor 134 may be coupled to the compressor 116 via the coupling 132. The coupling 132 may include a drive shaft, clutch, gears, pneumatics, and/or hydraulics. The motor 134 may provide additional energy to the system 100 to make up for losses due to inefficiencies. The motor 134 may also be used during start-up of the system 100 for driving the system 100 while temperatures and pressures settle to an operating state. The motor 134 may include a generator configured to convert excess power from the system 100 into electrical power. In various embodiments, the motor 134 includes an electrical motor, a steam engine, a turbine, an engine configured to burn fuel such as diesel, gasoline, natural gas, coal, methane, and/or the like.

A controller 136 may be coupled to the system 100 via a control coupling (not illustrated). The controller 136 may include one or more computer systems, processors, computer interfaces, memory, removable storage media or a combination thereof. The computer interfaces may include various combinations of wiring harnesses, relays, circuit boards, processors, optical transmitters, optical cable, optical receivers, wireless transmitters, wireless receivers, electrical actuators, a hydraulic lines, hydraulic actuators, pneumatic lines, and pneumatic actuators. The controller 136 may further communicate control commands to components of the system 100, including engines, motors, generators, valves, the compressors, turbines, heat exchangers, traps, and/or tanks.

The temperatures and pressures illustrated in FIG. 1 are approximate. These represent examples of temperatures and pressures that may be used for compressing and cooling hot exhaust gas to liquid carbon dioxide temperature for separation into liquid carbon dioxide and nitrogen gas, and then heating the nitrogen gas to drive a turbine while recovering energy using heat exchangers to mediate the heating and cooling. Other temperatures and/or pressures may be used.

FIG. 2 is a block diagram illustrating an alternative embodiment of a system 200 for separation of carbon dioxide from nitrogen, according to aspects of the invention. FIG. 2 differs from FIG. 1 in that the combustion of fuel is performed in an engine 210 that is coupled to the compressor 116 and/or 118. The engine 210 may be coupled using a drive shaft, clutch, gears, pneumatics, and/or hydraulics. For example, the coupling 132 may be a drive shaft. The drive shaft 132 may be used for connecting the turbines 126 and 130 directly to the compressors 116 and 118. The engine 210 may be directly connected to a drive shaft 132. Exhaust from the engine 210 may be provided to the regenerative heat exchanger 112. In various embodiments, the engine 210 is configured to burn fuels including diesel, gasoline, natural gas, coal, methane, and/or the like.

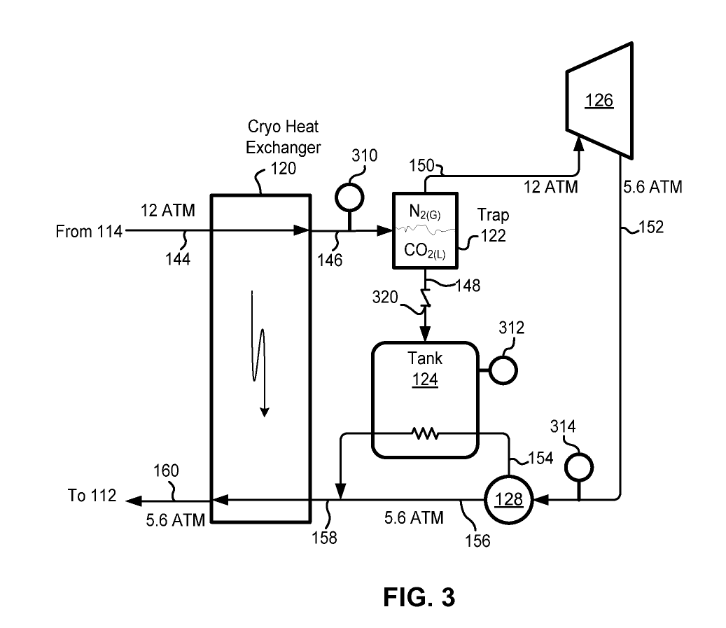

FIG. 3 is a block diagram illustrating details of the fluid trap 122 and the tank 124 of FIG. 1 or 2. The system 100 may include temperature and pressure sensors for monitoring the temperature and pressure of gases 140-164. The system 100 includes temperature sensors 310, 312, and 314. The system 100 of FIG. 3 further includes a check valve 320. The controller 136 may monitor sensors 310, 312, and 314 as well as other sensors, such as pressure sensors.

The controller 136 may use measured temperatures and/or pressures for controlling valves such as the bypass valve 128 and the check valve 320 during start-up. For example, at the beginning of a start-up process, the various components of the system 100 (including the fluid trap 122 and the tank 124) are at an ambient temperature and pressure. The motor 134 drives the compressor 116 and/or 118 to compress the exhaust gas 142 and output compressed exhaust gas 144. The intercooler 114 may maintain the compressed exhaust gas 144 at ambient temperature. Carbon dioxide in the compressed exhaust gas 146 is not liquid at ambient temp. Thus, the compressed nitrogen gas 150 initially includes carbon dioxide gas. The cryo turbine 126 releases the nitrogen gas 152 (including carbon dioxide gas) at a lower temperature than the nitrogen gas 150. The cryo heat exchanger 120 uses the lower temperature nitrogen gas (including carbon dioxide) to cool the compressed exhaust gas 146, thus, multiplying the cooling effect of the cryo turbine 126.

As the cryo heat exchanger 120 and cryo turbine 126 continue to cool the compressed exhaust gas 146 to liquid carbon dioxide temperature, the fluid trap 122 begins to separate liquid carbon dioxide 148 from nitrogen gas 150. The nitrogen gas 154 may be used to pre-cool the tank 124 from ambient temperature. The bypass valve 128 may direct nitrogen gas 154 to the tank 124 for pre-cooling the tank 124. Pre-cooling the tank 124 may decrease the pressure in the tank 124 below the pressure in the fluid trap 122. The check valve 320 may release liquid carbon dioxide 148 into the tank 124 when the pressure in the tank 124 is less than or equal to the pressure in the fluid trap 122.

When the fluid trap 122 and the tank 124 are stable at liquid carbon dioxide temperatures, the bypass valve 128 may direct the bypass nitrogen gas 156 to the cryo heat exchanger 120. The bypass valve 128 may direct a portion of the nitrogen gas 154 to the tank 124 to maintain the temperature of the tank 124 at or below liquid carbon dioxide temperature. Liquid carbon dioxide 148 may be removed from the tank 124 as a liquid. For example, liquid carbon dioxide 148 may be drained from the tank 124 at about a rate that maintains a constant pressure within the tank 124.

The controller 136 uses the temperatures returned from the temperature sensor 310, 312, and/or 314 to determine how much of the nitrogen gas 152 to direct to the tank 124 as nitrogen gas 154 or to the cryo heat exchanger 120 as bypass nitrogen gas 156. For example, during stable operation, the amount of nitrogen gas 154 may be increased as the temperature at 312 increases, and decreased as the temperature at sensor 312 decreases. During startup, the controller 136 may direct all of the nitrogen gas 152 to the tank 124 as nitrogen gas 154 until reaching stable operation at liquid carbon dioxide temperature. Then, the controller 136 may bypass the tank 124 using the bypass valve 128. The controller 136 may compare the temperature at sensor 312 to the temperature at sensor 310 and/or 314. The controller 136 may use techniques such as a proportional, integral, differential (PID) loop to control the bypass valve 128 based on the temperatures at sensors 310-314. The controller 136 may use pressures that are measured and returned from pressure sensors (not shown) to control the bypass valve 128.

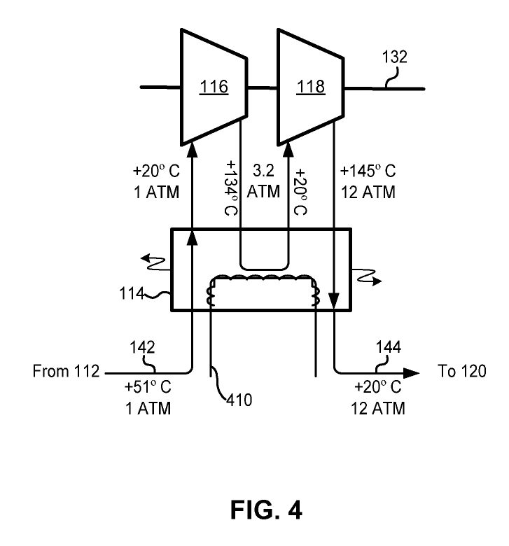

FIG. 4 is a block diagram illustrating details of the compressors 116 and 118 and the intercooler 114 of FIG. 1 or 2. Examples of the first stage compressor 116 and/or the second stage compressor 118 include a reciprocating piston compressor, a centrifugal compressor, a diagonal compressor, a mixed flow compressor, an axial-flow compressor, a rotary vane compressor, a scroll compressor, a diaphragm compressor, and/or the like.

The intercooler 114 is configured for cooling the exhaust gas between two or more stages of compression. This may be accomplished by transferring heat from the exhaust gas to the environment. The intercooler 114 of FIG. 4 pre-cools the exhaust gas 142 from about +51° C. to about +20° C. prior to the first stage compressor 116. The first stage compressor 116 of FIG. 4 outputs compressed exhaust gas at an intermediate pressure of about 3.2 ATM at about +134° C. The intercooler 114 cools and returns the exhaust gas to the second stage compressor 118 at about +20° C. The second stage compressor 118 may output the compressed exhaust gas at about 12 ATM and +145° C. to the intercooler 114 for cooling to +20° C. The intercooler 114 may output compressed exhaust gas 144 at high pressure and ambient temperature (e.g., about +20° C.) to the cryo heat exchanger 120.

The heat energy may be transferred from the compressed exhaust gas in the intercooler 114 to the environment using a heat exchanger 410. For example, the heat exchanger 410 may use a supply of cold water at ambient temperature for cooling the compressed exhaust gas in the intercooler 114 and discharge the heated water to the environment. For simplicity, two stages are illustrated in FIG. 4. However, additional stages are contemplated. Alternatively, a single stage of compression may be used. The temperatures and pressures set forth above are for illustration purposes. Other temperatures and pressures may be used.

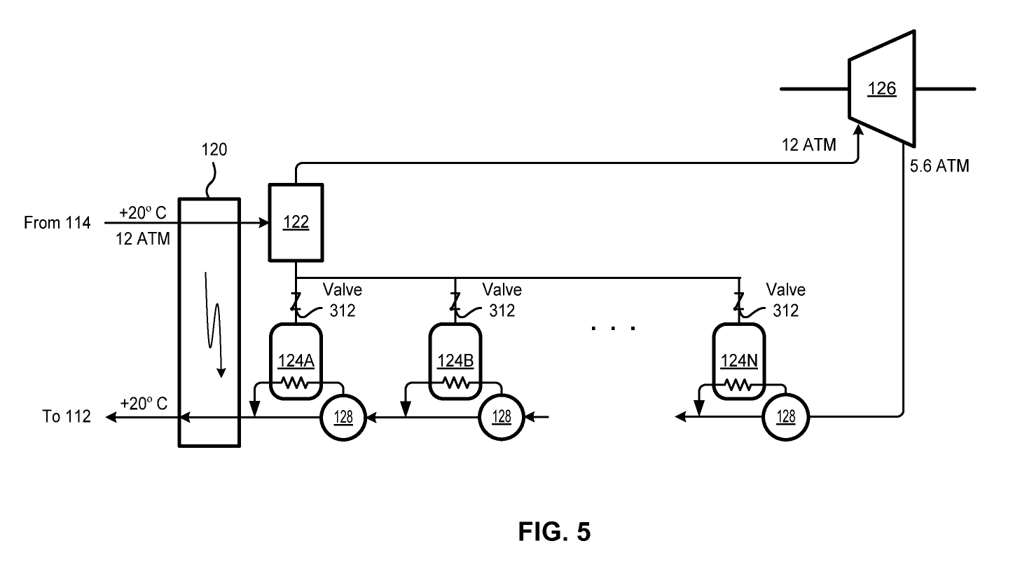

FIG. 5 is a block diagram illustrating an alternate embodiment of details of the cryo heat exchanger, fluid trap, and tank of FIG. 1 or 2. An array of tanks 124 (i.e., 124A, 124B, . . . 124N) may be used for storing liquid carbon dioxide. For example, as tank 124A fills up, a tank 124B may be used. As the tank 124B fills up, the next tank may be used, and so on, for up to N tanks. The array of tanks 124A-124N may be disposed in a series array, parallel array, or multidimensional array. The controller 136 may be used for determining a sequence for storing the liquid carbon dioxide and actuating valves.

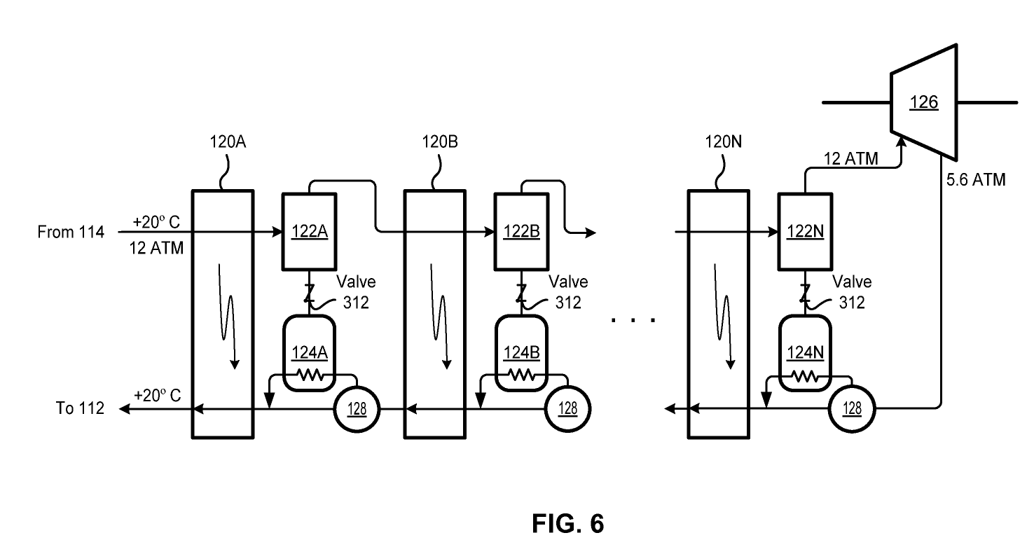

FIG. 6 is a block diagram illustrating an alternate embodiment of details of the cryo heat exchanger, fluid trap and tank of FIG. 1 or 2. Multiple stages (A, B, . . . N) of the cryo heat exchanger 120, fluid trap 122, and tank 124 may be used in series for separating molecules having successively lower phase change temperatures. A first stage comprising a cryo heat exchanger 120A, fluid trap 122A, and tank 124A may be used for cooling the compressed exhaust gas 144 to a liquid temperature for a first gas that is present in the compressed exhaust gas 144. As the first gas transitions to a liquid, the liquid may be separated in the fluid trap 122A and stored in the tank 124A. An example of the first gas is nitrogen dioxide, which is liquid below a temperature of about +21° C. at 12 ATM.

A second stage comprising a cryo heat exchanger 120B, fluid trap 122B, and tank 124B may be used for cooling the compressed exhaust gas 144 to a liquid temperature for a second gas that is present in the compressed exhaust gas 144. As the second gas transitions to a liquid, the liquid may be separated in the fluid trap 122B and stored in the tank 124B. An example of the second gas is sulfur dioxide which is liquid below a temperature of about −10° C. at 12 ATM. N stages may include a N^{th} stage comprising a cryo heat exchanger 120N, fluid trap 122N, and tank 124N and may be used for cooling a N^{th} gas in the compressed exhaust gas 144 to a N^{th} liquid temperature. For example, carbon dioxide may be the N^{th} gas. Thus, multiple components may be individually separated from the exhaust gas 140. The controller 136 may be used for controlling valves to maintain the temperatures and pressures for the heat exchangers 120A-N, traps 122A-N, and tanks 124A-N.

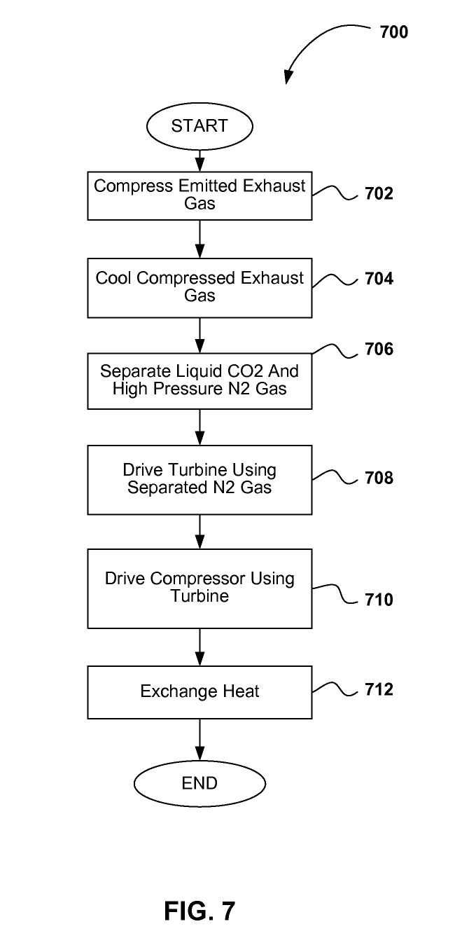

FIG. 7 is a flow diagram of an exemplary process 700 for separating carbon dioxide from nitrogen in exhaust gas emitted from a combustion of fuel, according to various embodiments of the technology. In step 702, emitted exhaust gas 140 is compressed using a compressor. The compressor may include multiple stages and an intercooler. In step 704, the compressed exhaust gas from the compressor is cooled to a temperature that results in the compressed carbon dioxide gas becoming a liquid while the compressed nitrogen remains a gas. In step 706, the liquid carbon dioxide is separated from compressed cold nitrogen. In step 708, the cold compressed nitrogen gas is used to drive a turbine. In step 710, the turbine is used to drive the compressor. A two stage turbine may be used for driving the compressor. A first stage turbine may be used to partially decompress the nitrogen gas to a medium pressure and further cool the nitrogen gas to cryo temperature. A second stage turbine may provide most of the power for driving the compressor using the medium pressure nitrogen gas. In step 712, heat is exchanged between compressed exhaust gas and the medium pressure nitrogen gas. The heat exchange may warm the medium pressure nitrogen gas from cryo-temperature to ambient temperature while cooling the compressed carbon dioxide from ambient temperature to liquid carbon dioxide temperature, as described in step 704. Additionally, heat may be exchanged between the medium pressure nitrogen gas at ambient temperature and the emitted exhaust gas to further heat the medium pressure nitrogen. The heat exchange may heat the medium pressure nitrogen gas from ambient temperature to combustion temperature while cooling the emitted exhaust gas from combustion temperature to ambient temperature. The medium pressure nitrogen gas at combustion temperature may be used to drive the second stage of the turbine. The second stage may release the nitrogen gas at ambient pressure.

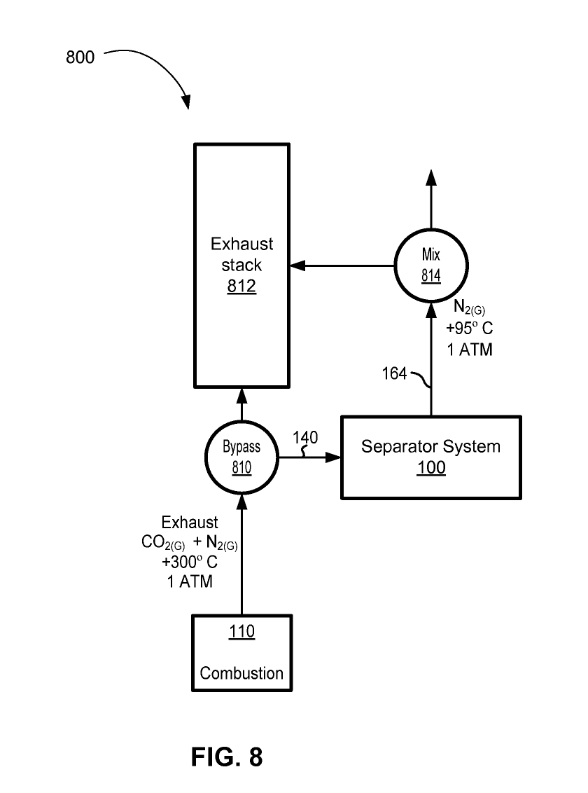

FIG. 8 is a block diagram illustrating a use of the system 100 of FIG. 1 in a combustion system 800. The combustion system 800 includes a bypass valve 810, an exhaust stack 812, and an optional mixing valve 814. The bypass valve 810 is configured to direct exhaust from the combustion module 110 to the separator system 100 and the exhaust stack 812. All or a portion of the exhaust emitted from the combustion module may directed to the separator system 100. The separator system is configured to separate liquid carbon dioxide 148 from exhaust gas 140 and emit nitrogen gas 164, as discussed elsewhere herein. The liquid carbon dioxide 148 may be removed from the separator system 100 as a liquid, a solid, or a gas. The nitrogen gas 164 from the separator system 100 may be emitted to the environment via the mixing valve 814. Optionally, all or a portion of the nitrogen gas 164 is introduced into the exhaust stack 812 via the mixing valve 814 for mixing with untreated exhaust. The bypass valve 810 is further configured to direct all or a portion of the exhaust to the exhaust stack, for example, during maintenance of the separator system or heavy use of the combustion module 110. In another example, the combustion system 800 represents a ship and the combustion module 110 represents an engine onboard the ship. The separator system 100 may be bypassed during operation at sea and then used at port or in pollution sensitive areas to for capture and sequestration of carbon dioxide emissions. The controller 136 may be used for controlling the bypass valves based on temperatures and/or pressures received from sensors.

Several embodiments are specifically illustrated and/or described herein. However, it will be appreciated that modifications and variations are covered by the above teachings and within the scope of the appended claims without departing from the spirit and intended scope thereof. For example, specific temperatures and pressures are recited in examples and figures. The specific temperatures and pressures are intended as examples and other temperatures and pressures within the scope of the claims may be used without departing from the invention. For example, separation of carbon dioxide is described. However, other components may be separated from exhaust gas including SO₃, NO₂, SO₂, NO, CO, hydrocarbons, and etc. Various embodiments of the invention include logic stored on computer readable media, the logic configured to perform methods of the invention.

In the foregoing specification, the present invention is described with reference to specific embodiments thereof, but those skilled in the art will recognize that the present invention is not limited thereto. Various features and aspects of the above-described present invention may be used individually or jointly. Features in each of the various illustrations may be combined with features in other illustrations or used individually for illustrating the present invention. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A system for separating carbon dioxide from nitrogen in exhaust gas from combustion of fuel, the system comprising:
a compressor configured to compress the exhaust gas;
a heat exchanger configured to cool the compressed exhaust gas to liquid carbon dioxide temperature;
a fluid trap configured to separate liquid carbon dioxide from compressed nitrogen gas in the compressed exhaust gas;
a tank configured to store the separated liquid carbon dioxide; and
a turbine coupled to the compressor and in communication with the fluid trap, the turbine configured to use the separated compressed nitrogen gas from the fluid trap for driving the compressor.

2. The system of claim 1, wherein the turbine includes a first stage and a second stage, the heat exchanger configured to warm the nitrogen gas between the first stage and the second stage using heat received from cooling the compressed exhaust gas to liquid carbon dioxide temperature.

3. The system of claim 2, further comprising a regenerative heat exchanger configured to cool the exhaust gas from a combustion temperature to ambient temperature before introduction into the compressor and to warm the nitrogen gas between the first stage and the second stage using heat transferred from cooling the exhaust gas.

4. The system of claim 1, wherein the turbine includes a first stage and a second stage and the heat exchanger includes a cryo heat exchanger and a regenerative heat exchanger,
the cryo heat exchanger disposed between the first stage and the regenerative heat exchanger and configured to warm nitrogen gas received from the first stage, using heat transferred during cooling the compressed exhaust gas to liquid carbon dioxide temperature,
the regenerative heat exchanger disposed between the cryo heat exchanger and the second stage and configured to warm nitrogen gas received from the cryo heat exchanger, using heat transferred during cooling the exhaust gas from combustion temperature to ambient temperature for introduction into the compressor

5. The system of claim 1, wherein the compressor comprises:
a first stage;
a second stage;
an intercooler between the first stage and the second stage;
a pre-cooler configured to transfer heat from the exhaust gas to the environment; and
a post cooler between the second stage and the heat exchanger, the post cooler configured to transfer heat from the exhaust gas to the environment.

6. The system of claim 1, wherein the compressor is configured to compress the exhaust gas to a pressure of greater than about 10 atmospheres and the liquid carbon dioxide temperature is less than about −35° C.

7. A method for separating carbon dioxide from nitrogen in exhaust gas emitted from a combustion of fuel, the method comprising:
compressing the emitted exhaust gas in a compressor from ambient pressure to high pressure;
cooling the high-pressure exhaust gas from ambient temperature to liquid carbon dioxide temperature;
separating liquid carbon dioxide from high-pressure nitrogen gas at liquid carbon dioxide temperature;
driving a turbine using the separated high-pressure nitrogen gas;
driving the compressor using the turbine; and
exchanging heat between the compressed exhaust gas and nitrogen gas released from the turbine to cool the compressed exhaust gas to liquid carbon dioxide temperature and to warm the released nitrogen gas.

8. The method of claim 7, further comprising:
releasing medium pressure nitrogen gas from a first stage of the turbine at cryo-temperature;
exchanging heat between the emitted exhaust gas and the medium pressure nitrogen gas to cool the emitted exhaust gas and to heat the medium pressure nitrogen gas;
driving a second stage of the turbine using the heated medium pressure nitrogen gas; and
releasing ambient pressure nitrogen gas from the second stage, the first and second stage of the turbine configured to drive the compressor.

9. The method of claim 8, further comprising cooling the separated carbon dioxide using the medium pressure nitrogen gas released from the first stage of the compressor.

10. The method of claim 8, wherein medium pressure is greater than about three atmospheres and less than about seven atmospheres and cryo-temperature is less than about −100° C.

11. The method of claim 7, further comprising
exchanging heat between emitted exhaust gas emitted and nitrogen gas released from a first stage of the turbine to cool the emitted exhaust gas and to warm the nitrogen gas; and
driving a second stage of the turbine using the warmed nitrogen gas, the first and second stage of the turbine configured to drive the compressor.

12. The method of claim 7, wherein high pressure is greater than about 10 atmospheres and liquid carbon dioxide temperature is less than about −30° C.

13. The method of claim 7, further comprising decompressing the liquid carbon dioxide and cooling the liquid carbon dioxide to solid carbon dioxide.

14. A system for separating carbon dioxide from nitrogen in exhaust gas emitted during combustion of fuel, the system comprising:
a regenerative heat exchanger configured to cool hot exhaust gas from combustion temperature to ambient temperature;
a compressor configured to compress the ambient-temperature exhaust gas from ambient pressure to high pressure;
a cryo heat exchanger configured to cool the high-pressure exhaust gas from ambient temperature to cryo-temperature;
a trap configured to separate liquid carbon dioxide from nitrogen gas in the cryo-temperature exhaust;
a two stage turbine in fluid communication with the trap, the cryo heat exchanger and regenerative heat exchanger,
the first stage configured to use the high-pressure nitrogen gas from the trap for driving the compressor, and to release the nitrogen gas at a medium pressure,
the cryo heat exchanger configured to warm the released nitrogen gas from the first stage using the cooling of the high-pressure exhaust gas,
the regenerative heat exchanger configured to warm the released nitrogen gas from the cryo heat exchanger using the cooling of the hot exhaust gas,
the second stage configured to use the warmed nitrogen gas from the regenerative heat exchanger to drive to drive the compressor.

15. The system of claim 14, further comprising a tank in fluid communication with the trap and configured to store liquid carbon dioxide received from the trap.

16. The system of claim 14, wherein ambient temperature is from about −10° C. to about +100° C.

17. The system of claim 14, wherein cryo-temperature is from about −170° C. to about −20° C.

18. The system of claim 14, wherein combustion temperature is greater than about +200° C.

19. The system of claim 14, wherein high pressure is greater than about 8 atmospheres.

20. The system of claim 14, wherein medium pressure is between 2 and 8 atmospheres.

21. The system of claim 14, wherein the cryo heat exchanger comprises a plurality of stages, each stage in fluid communication with the trap.

22. The system of claim 14, wherein the cryo heat exchanger and the trap comprise a two stages,
the first stage including a first cryo heat exchanger configured to cool the exhaust gas to a liquid temperature of a molecule and a first trap configured for separating the liquid molecule from the exhaust gas,
the second stage including a second cryo heat exchanger configured to cool the exhaust gas to liquid temperature of carbon dioxide and a second trap configured for separating the liquid carbon dioxide from the exhaust gas.

23. The system of claim 22, wherein the molecule is sulfite, nitrogen dioxide, or sulfur dioxide.
